(19) United States
(12) Patent Application Publication
(10) Pub. No.: US 2013/0244623 A1
(43) Pub. Date: Sep. 19, 2013

(54) Updating Contact Information In A Mobile Communications Device

(71) Applicants: Gary D. Cudak, Creedmoor, NC (US); Christopher J. Hardee, Raleigh, NC (US); Randall C. Humes, Raleigh, NC (US); Adam Roberts, Moncure, NC (US)

(72) Inventors: Gary D. Cudak, Creedmoor, NC (US); Christopher J. Hardee, Raleigh, NC (US); Randall C. Humes, Raleigh, NC (US); Adam Roberts, Moncure, NC (US)

(73) Assignee: International Business Machines Corporation, Armonk, NY (US)

(21) Appl. No.: 13/422,237

(22) Filed: Mar. 16, 2012

(51) Int. Cl. H04W 4/00; H04M 3/42

(52) U.S. Cl. 455/414.1

(57) ABSTRACT

Updating contact information in a mobile communications device, including: identifying, by the mobile communications device, call information associated with an inbound call; identifying, by the mobile communications device, contact information stored in the mobile communications device that is associated with the call information; determining, by the mobile communications device, whether the contact information stored in the mobile communications device includes information contained in the call information; and responsive to determining that the contact information stored in the mobile communications device does not include information contained in the call information, updating, by the mobile communications device, the contact information stored in the mobile communications device in dependence upon the call information.

### BACKGROUND OF THE INVENTION

1. Field of the Invention

The field of the invention is data processing, or, more specifically, methods, apparatus, and products for updating contact information in a mobile communications device.

2. Description of Related Art

Mobile communications devices can include contact lists for storing contacts known by the user of the mobile communications device. Contact lists allow people to quickly and conveniently connect with someone. There are cases where it is not sufficient to have a static list of contacts with their associated information. For instance, when a caller calls from a number that is not in their contact information or when the call comes from behind a larger phone system that does not transmit the extension from which the call originated.

### SUMMARY OF THE INVENTION

Methods, apparatus, and products for updating contact information in a mobile communications device, including: identifying, by the mobile communications device, call information associated with an inbound call; identifying, by the mobile communications device, contact information stored in the mobile communications device that is associated with the call information; determining, by the mobile communications device, whether the contact information stored in the mobile communications device includes information contained in the call information; and responsive to determining that the contact information stored in the mobile communications device does not include information contained in the call information, updating, by the mobile communications device, the contact information stored in the mobile communications device in dependence upon the call information.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example mobile communications device useful in updating contact information according to embodiments of the present invention.

FIG. 2 sets forth a flow chart illustrating an example method for updating contact information in a mobile communications device according to embodiments of the present invention.

FIG. 3 sets forth a flow chart illustrating a further example method for updating contact information in a mobile communications device according to embodiments of the present invention.

FIG. 4 sets forth a flow chart illustrating a further example method for updating contact information in a mobile communications device according to embodiments of the present invention.

### DETAILED DESCRIPTION OF EXAMPLE EMBODIMENTS

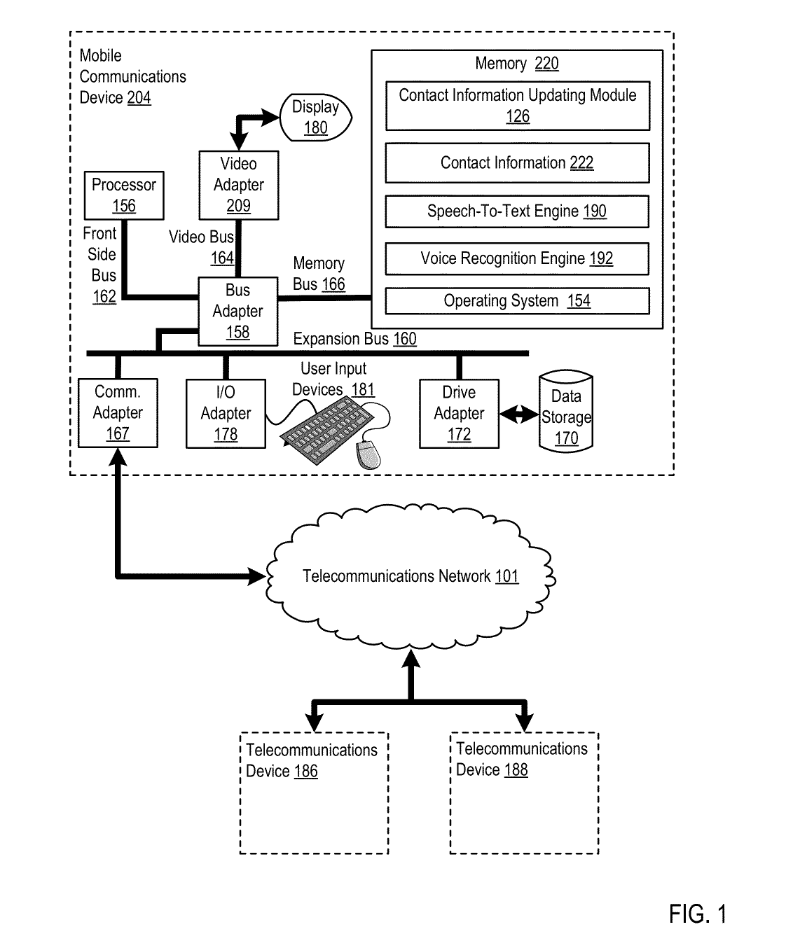

Example methods, apparatus, and products for updating contact information in a mobile communications device in accordance with the present invention are described with reference to the accompanying drawings, beginning with FIG. 1. FIG. 1 sets forth a block diagram of automated computing machinery comprising an example mobile communications device (204) useful in updating contact information according to embodiments of the present invention. The mobile communications device (204) of FIG. 1 includes at least one computer processor (156) or ‘CPU’ as well as computer memory (220) which is connected through a high speed memory bus (166) and bus adapter (158) to processor (156) and to other components of the mobile communications device (204). In the example of FIG. 1, such computer memory (220) may be embodied, for example, as a memory card, flash memory, randomly accessible memory, and so on.

Stored in computer memory (220) is contact information (222). Such contact information may include, for example, a call history list that includes information identifying the source of received phone calls, information identifying the target of phone calls initiated on the mobile communications device (204), and so on. The contact information (222) may also include information identifying contacts stored in the mobile communications device (204). Each contact may include, for example, a name for the contact, one or more phone numbers for the contact, an email address for the contact, a physical address for the contact, and so on.

Also stored in the computer memory (220) is a contact information updating module (126), a module of computer program instructions for updating contact information (220) in the mobile communications device (204) according to embodiments of the present invention. In the example of FIG. 1, the contact information updating module (126) is configured to identify call information associated with an inbound call. The inbound call can represent incoming communications that are received by the mobile communications device (204) over a data communications network. The inbound call is ‘inbound’ in the sense that the inbound call is initiated by another communications device such as, for example, another mobile communications device, a landline telephone, and so on.

In the example of FIG. 1, call information associated with an inbound call may be embodied as information identifying the device that originated the inbound call, information identifying a person that that originated the inbound call through the use of a communications device, and so on. Identifying call information associated with an inbound call may be carried out, for example, by extracting caller ID information associated with the inbound call, by extrapolating call information from the content of the call itself, and so on.

The contact information updating module (126) of FIG. 1 is further configured to identify contact information (222) stored in the mobile communications device (204) that is associated with the call information. Identifying contact information (222) stored in the mobile communications device (204) that is associated with the call information may be carried out, for example, by searching the contact information (222) stored in the mobile communications device (204) for an entry that corresponds to the call information.

The contact information updating module (126) of FIG. 1 is further configured to determine whether the contact information (222) stored in the mobile communications device (204) includes information contained in the call information. Determining whether the contact information (222) stored in the mobile communications device (204) includes information contained in the call information may be carried out, for example, by comparing information contained in the contact information (222) to the call information to identify a match or lack thereof.

The contact information updating module (126) of FIG. 1 is further configured to update the contact information (222) stored in the mobile communications device (204) in dependence upon the call information. Updating the contact information (222) stored in the mobile communications device (204) in dependence upon the call information is carried out in response to determining that the contact information stored in the mobile communications device does not include information contained in the call information.

Also stored in computer memory (220) is a speech-to-text engine (190). In the example of FIG. 1, the speech-to-text engine (190) may be embodied as a module of computer program instructions for converting speech into text. The speech-to-text engine (190) of FIG. 1 may be configured, for example, to convert speech uttered by a caller to extrapolate information about the caller.

Also stored in computer memory (220) is a voice recognition engine (192). In the example of FIG. 1, the voice recognition engine (192) may be embodied as a module of computer program instructions for determining characteristics of a speaker's voice such as the speaker's tone, the speaker's voice frequency, and so on. The voice recognition engine (192) of FIG. 1 may be configured, for example, to measure characteristics of a caller's voice to extrapolate information about the caller.

Also stored in computer memory (220) is an operating system (154). Operating systems useful updating contact information (222) in a mobile communications device (204) according to embodiments of the present invention can include Apple™ iOS, Palm OS, Android, Blackberry OS, and others as will occur to those of skill in the art. The operating system (154), contact information (222), contact information updating module (126), speech-to-text engine (190), and voice recognition engine (192) in the example of FIG. 1 are shown in computer memory (220), but many components of such software typically are stored in non-volatile memory also, such as, for example, on a flash memory data storage (170) device.

The mobile communications device (204) of FIG. 1 includes drive adapter (172) coupled through expansion bus (160) and bus adapter (158) to processor (156) and other components of the mobile communications device (204). Drive adapter (172) connects non-volatile data storage to the mobile communications device (204) in the form of disk drive (170).

The example mobile communications device (204) of FIG. 1 includes one or more input/output ('I/O′) adapters (178). I/O adapters implement user-oriented input/output through, for example, software drivers and computer hardware for controlling output to display devices such as computer display screens, as well as user input from user input devices (181) such as keyboards, special purpose buttons, a touchscreen display, and so on. The example mobile communications device (204) of FIG. 1 includes a video adapter (209), which is an example of an I/O adapter specially designed for graphic output to a display device (180) such as a display screen or touchscreen display. Video adapter (209) is connected to processor (156) through a high speed video bus (164), bus adapter (158), and the front side bus (162), which is also a high speed bus.

The example mobile communications device (204) of FIG. 1 includes a communications adapter (167) for data communications with other telecommunications devices (186, 188) and for data communications with a telecommunications network (101). The communications adapter (167) may utilize an antenna or other device for receiving data via the telecommunications network (101).

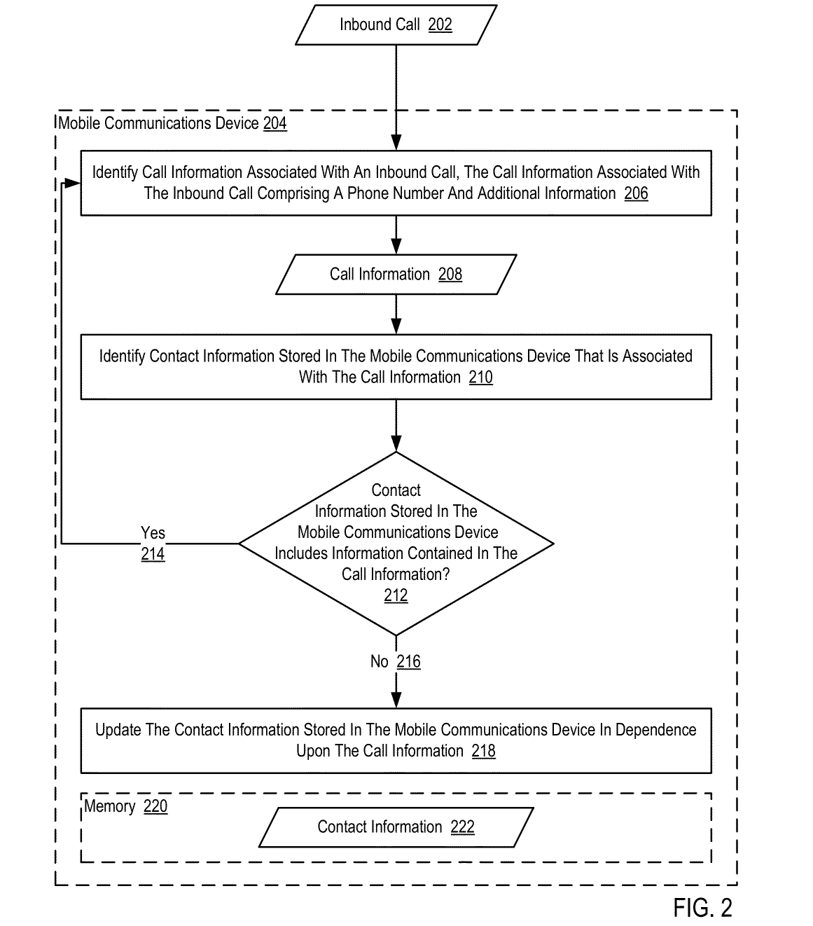

For further explanation, FIG. 2 sets forth a flow chart illustrating an example method for updating contact information in a mobile communications device (204) according to embodiments of the present invention. The mobile communications device (204) of FIG. 2 may be embodied, for example, as a mobile phone, smartphone, or other mobile device configured for data communications over a communications network such as a cellular network, mobile telecommunications network, IP network, and so on.

The example method of FIG. 2 includes identifying (206), by the mobile communications device (204), call information (208) associated with an inbound call (202). In the example method of FIG. 2, the inbound call (202) represents incoming communications that is received by the mobile communications device (204) over a data communications network. The inbound call (202) is ‘inbound’ in the sense that the inbound call (202) is initiated by another communications device such as, for example, another mobile communications device, a landline telephone, and so on. In the example method of FIG. 2, although the inbound call (202) is described as a ‘call’ in which users communicate vocally, readers will appreciate that the inbound call (202) may also be embodied as a text message, multimedia message, or other form of data communications capable of being received by the mobile communications device (204).

In the example method of FIG. 2, call information (208) associated with an inbound call (202) includes a phone number and additional information such as, for example, information identifying the device that originated the inbound call (202), information identifying a person that that originated the inbound call (202) through the use of a communications device, and so on. Identifying (206) call information (208) associated with an inbound call (202) may be carried out, for example, by extracting caller ID information associated with the inbound call (202), by extrapolating call information (208) from the content of the call itself, and so on. Consider an example in which an inbound call (202) is received by the mobile communications device (204) and the following dialogue occurs:
Callee: “Hello.”
Caller: “Hey Bill, it's Mom. I′m at the restaurant.”

In such an example, call information (208) associated with an inbound call (202) may be extrapolated from the content of the call itself. For example, the mobile communications device (204) may include speech-to-text capabilities such that the mobile communications device (204) can record the dialogue exchanged between the caller and callee, convert the recorded dialogue to text, and search the text for call information (208) associated with an inbound call (202). In the example described above, call information (208) associated with an inbound call (202) can include an identification of the caller (“Mom”).

The example method of FIG. 2 also includes identifying (210), by the mobile communications device (204), contact information (222) stored in the mobile communications device (204) that is associated with the call information (208). In the example method of FIG. 2, contact information (222) stored in the mobile communications device (204) may be embodied, for example, as a contacts list stored in the mobile communications device (204), as a history of calls received by the mobile communications device (204), and so on. In the example method of FIG. 2, identifying (210) contact information (222) stored in the mobile communications device (204) that is associated with the call information (208) may be carried out, for example, by searching the contact information (222) stored in the mobile communications device (204) for an entry that corresponds to the call information (208).

Consider the example described above in which the identification of the caller (“Mom”) was extrapolated from the content of the call itself. In such an example, contact information (222) stored in the mobile communications device (204) may be searched for an entry for the caller (“Mom”). For example, a contacts list stored in the mobile communications device (204) may be searched for an entry for a contact identified as “Mom.” In such an example, even if the caller originated the call from a phone number that is not stored in the mobile communications device (204), the mobile communications device (204) may still identify the phone number as being associated with a known contact that is stored in the mobile communications device (204).

The example method of FIG. 2 also includes determining (212), by the mobile communications device (204), whether the contact information (222) stored in the mobile communications device (204) includes information contained in the call information (208). In the example method of FIG. 2, determining (212) whether the contact information (222) stored in the mobile communications device (204) includes information contained in the call information (208) may be carried out, for example, by comparing information contained in the contact information (222) to the call information (208) to identify a match or lack thereof. Consider the example described above in which the caller has identified themself as “Mom.” In such an example, the contacts list stored in the mobile communications device (204) may be search for an entry in which the contact is identified as “Mom.” In such an example, the phone number from which the inbound call (202) was originated may be compared to the phone number associated with the contact is identified as “Mom.” If the phone number from which the inbound call (202) was originated does (214) match the phone number associated with the contact is identified as “Mom,” it is determined that the contact information (222) stored in the mobile communications device (204) does include information contained in the call information (208). Alternatively, if the phone number from which the inbound call (202) was originated does not (216) match the phone number associated with the contact is identified as “Mom,” it is determined that the contact information (222) stored in the mobile communications device (204) does not include information contained in the call information (208)

The example method of FIG. 2 also includes updating (218), by the mobile communications device (204), the contact information (222) stored in the mobile communications device (204) in dependence upon the call information (208). In the example method of FIG. 2, updating (218) the contact information (222) stored in the mobile communications device (204) in dependence upon the call information (208) is carried out in response to determining that the contact information stored in the mobile communications device does not include information contained in the call information. Consider the example described above in which the caller has identified themself as “Mom.” In such an example, if it is determined (212) that the phone number from which the inbound call (202) was originated does not (216) match the contact information (222) for a contact identified as “Mom,” the contact information for the contact identified as “Mom” may be updated (216) to include the phone number from which the inbound call (202) was originated. In such an example, the phone number from which the inbound call (202) was originated may represent a new phone number for the contact, a temporary phone number at which the contact can be reached, and so on. Readers will appreciate that such an update may be retained indefinitely, for a predetermined period of time, and so on.

In the example method of FIG. 2, the call information (208) may include the phone number from which a call originated, the location of the caller when the call was originated, and additional information as will occur to those of skill in the art. Updating (218) the contact information (222) stored in the mobile communications device (204) in dependence upon the call information (208) may therefore include adding or updating the phone number associated with the contact, a location or description of a location associated with a particular contact or phone number, or adding any additional information that can be extracted from the call information (208).

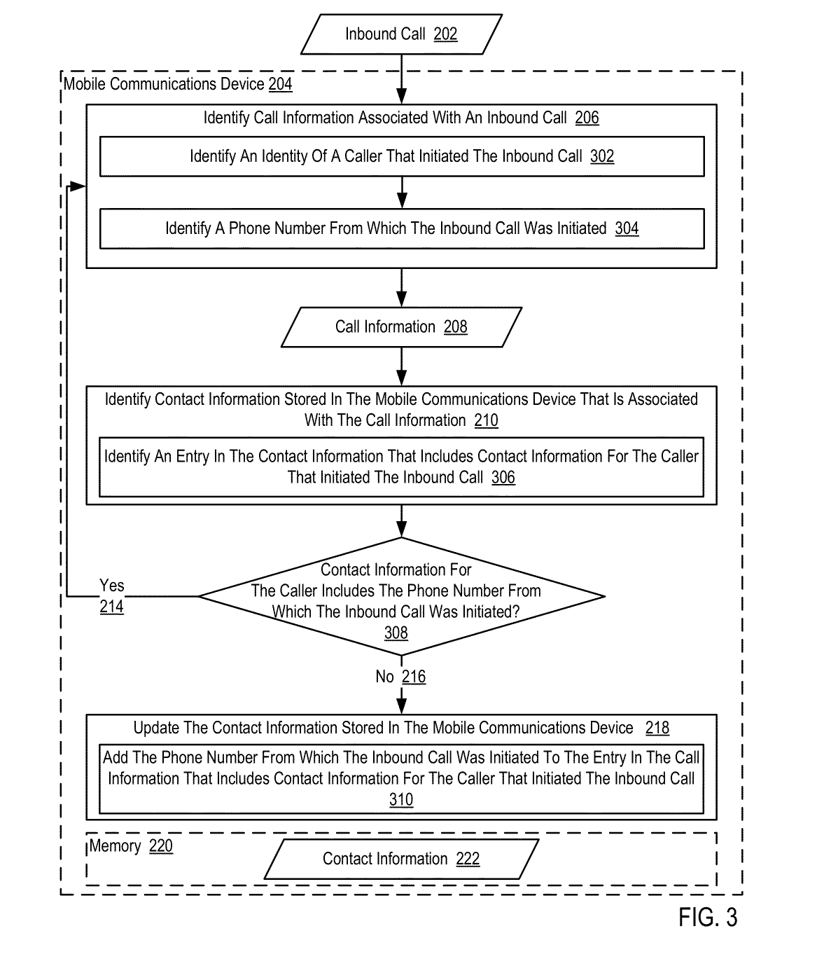

For further explanation, FIG. 3 sets forth a flow chart illustrating a further example method for updating contact information in a mobile communications device according to embodiments of the present invention. The example method of FIG. 3 is similar to the example method of FIG. 2 as it also includes identifying (206) call information (208) associated with an inbound call (202), identifying (210) contact information (222) stored in the mobile communications device (204) that is associated with the call information (208), determining (212 in FIG. 2) whether the contact information (222) stored in the mobile communications device (204) includes information contained in the call information (208), and updating (218) the contact information (222) stored in the mobile communications device (204) in dependence upon the call information (208).

In the example method of FIG. 3, identifying (206) call information (208) associated with the inbound call (202) includes identifying (302) an identity of a caller that initiated the inbound call (202). In the example method of FIG. 3, identifying (302) an identity of a caller that initiated the inbound call (202) may be carried out, for example, by extrapolating the identity of the caller that initiated the inbound call (202) from the content of the call itself. For example, dialogue spoken during the call may be analyzed using speech-to-text technologies as described above, by using voice recognition technologies to match the voice of a caller to a stored voice profile entry, by prompting the caller to identify themself when the call is originated, and so on.

In the example method of FIG. 3, identifying (206) call information (208) associated with the inbound call (202) also includes identifying (304) a phone number from which the inbound call (202) was initiated. In the example method of FIG. 3, identifying (304) a phone number from which the inbound call (202) was initiated may be carried out, for example, by extracting such information from caller ID information from received with the inbound call (202).

In the example method of FIG. 3, identifying (210) contact information (222) stored in the mobile communications device (204) that is associated with the call information (208) includes identifying (306) an entry in the contact information (222) that includes contact information for the caller that initiated the inbound call (202). In the example method of FIG. 3, identifying (306) an entry in the contact information (222) that includes contact information for the caller that initiated the inbound call (202) may be carried out, for example, by searching a call history list for an entry that represents a call to or call from the caller that initiated the inbound call (202), by searching a contacts list for an entry that represents contact information for the caller that initiated the inbound call (202), and so on.

In the example method of FIG. 3, determining (212 in FIG. 2) whether the contact information (222) stored in the mobile communications device (204) includes information contained in the call information (208) includes determining (312) whether the entry in the contact information (222) for the caller that initiated the inbound call (202) includes the phone number from which the inbound call (202) was initiated. In the example method of FIG. 3, determining (312) whether the entry in the contact information (222) for the caller that initiated the inbound call (202) includes the phone number from which the inbound call (202) was initiated may be carried out, for example, by comparing the phone number associated with an entry in a call history list to the phone number from which the inbound call (202) was initiated, by comparing the phone number associated with an entry in a contacts list to the phone number from which the inbound call (202) was initiated, and so on.

In the example method of FIG. 3, updating (218) the contact information (222) stored in the mobile communications device (204) in dependence upon the call information (208) includes adding (310) the phone number from which the inbound call (202) was initiated to the entry in the call information (222) that includes contact information for the caller that initiated the inbound call (202). In the example method of FIG. 3, adding (310) the phone number from which the inbound call (202) was initiated to the entry in the call information (222) that includes contact information for the caller that initiated the inbound call (202) may be carried out, for example, by adding (310) the phone number from which the inbound call (202) was initiated to an entry in a contact list for the caller that initiated the inbound call (202).

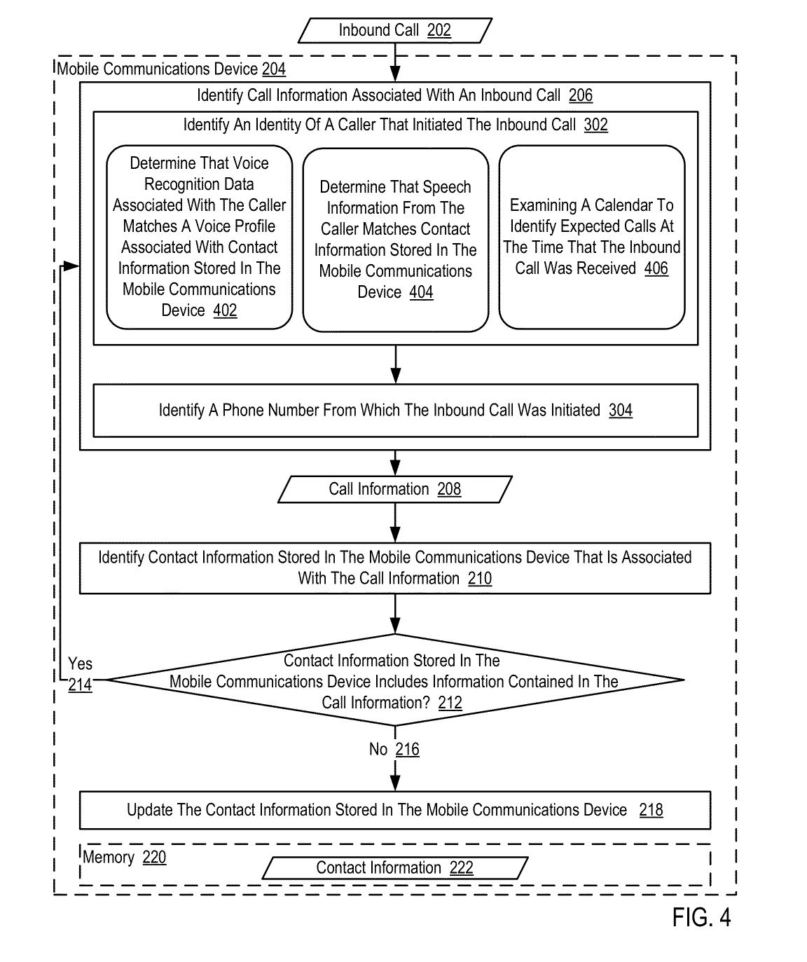

For further explanation, FIG. 4 sets forth a flow chart illustrating a further example method for updating contact information in a mobile communications device according to embodiments of the present invention. The example method of FIG. 4 is similar to the example method of FIG. 2 as it also includes identifying (206) call information (208) associated with an inbound call (202), identifying (210) contact information (222) stored in the mobile communications device (204) that is associated with the call information (208), determining (212) whether the contact information (222) stored in the mobile communications device (204) includes information contained in the call information (208), and updating (218) the contact information (222) stored in the mobile communications device (204) in dependence upon the call information (208).

In the example method of FIG. 4, identifying (302) an identity of a caller that initiated the inbound call (202) can include determining (402) that voice recognition data associated with the caller matches a voice profile associated with contact information (222) stored in the mobile communications device (204). In the example method of FIG. 4, voice recognition data associated with the caller may be obtained, for example, by recording speech of the caller during the call itself. In the example method of FIG. 4, the voice recognition data associated with the caller may be analyzed to determine, for example, a tone at which the caller speaks, the frequency of the caller's speech, and so on. The voice recognition data associated with the caller may be compared to a voice profile associated with contact information (222) stored in the mobile communications device (204).

In the example method of FIG. 4, the mobile communications device (204) may include a voice profile that is associated with contact information (222) stored in the mobile communications device (204). For example, each entry in a contact list stored in the mobile communications device (204) may include an associated voice profile that includes voice data for the person associated with a particular entry in the contact list. The voice profile may include information that can be used to match voice recognition data associated with a caller to an entry in the contact list. The voice profile may include, for example, data describing the tone at which a person associated with a particular entry in the contact list speaks, data describing the frequency at which a person associated with a particular entry in the contact list speaks, and so on.

In the example method of FIG. 4, determining (402) that voice recognition data associated with the caller matches a voice profile associated with contact information (222) stored in the mobile communications device (204) may be carried out by comparing voice recognition data associated with the caller to each voice profile associated with contact information (222) stored in the mobile communications device (204) to identify contact information (222) stored in the mobile communications device (204) that represents a best match to voice recognition data associated with the caller. In such a way, the identity of a caller and the corresponding contact information (222) associated with the caller may be identified using the vocal characteristics of the caller.

In the example method of FIG. 4, identifying (302) an identity of a caller that initiated the inbound call (202) can alternatively include determining (404) that speech information from the caller matches contact information (222) stored in the mobile communications device (204). In the example method of FIG. 4, determining (404) that speech information from the caller matches contact information (222) stored in the mobile communications device (204) may be carried out, for example, by converting speech of the caller to text and searching the text for information indicating that the caller is associated with a particular entry in the contact information (222) stored in the mobile communications device (204). In such an example, the caller may be prompted to speak their name when the call is initiated, the identity of the caller may gleaned from the natural dialogue of the conversation, and so on.

In the example method of FIG. 4, identifying (302) an identity of a caller that initiated the inbound call (202) can alternatively include examining (406) a calendar to identify expected calls at the time that the inbound call (202) was received. For example, an entry in a calendar supported by the mobile communications device (204) may have an entry for a business related phone call with a party identified as “Jim” that is scheduled to occur at 7:00 PM. Upon receipt of a call at or around 7:00 PM, the mobile communications device (204) may infer that “Jim” is calling and may therefore associate the phone number from which the inbound call (202) was received with an entry for “Jim” in a contact list maintained by the mobile communications device (204).

Although the alternative approaches for identifying (302) the identity of a caller are described separately, readers will appreciate that any combination of such approaches may be used. For example, identifying (302) the identity of a caller may include examining (406) a calendar to identify expected calls at the time that the inbound call (202) was received, determining (404) that speech information from the caller matches contact information (222) stored in the mobile communications device (204), and determining (402) that voice recognition data associated with the caller matches a voice profile associated with contact information (222) stored in the mobile communications device (204), or any combination thereof. Furthermore, identifying (302) the identity of a caller may be carried out in other ways such as, for example, using a call history list to identify a common time at which that a particular callers calls the mobile communications device (204), using routing information such as an IP address from which a voice over IP (‘VoIP’) call originated, and so on.

In the example described above, contact information (222) stored in the mobile communications device (204) is described primarily as including a contacts list maintained in the mobile communications device (204). Such a contact list may include an identifier of a contact such as a name, one or more phone numbers for the contact, an email address for the contact, a physical address for the contact, and so on. Readers will appreciate that contact information (222) stored in the mobile communications device (204) may take other forms as well. For example, contact information (222) stored in the mobile communications device (204) may also be embodied as a call history list that includes information identifying the source of calls received by the mobile communications device (204), information identifying the target of calls originated by the mobile communications device (204), and so on.

Consider an example in which contact information (222) stored in the mobile communications device (204) is embodied as a call history list that includes information identifying the source of calls received by the mobile communications device (204). In such an example, techniques described above may be used to identify the identity of a caller and to identify an entry in a contact list that is associated with the caller. In such an example, the call history list may be updated in dependence upon the identity of the caller and information contained in the contact list entry that is associated with the caller. For example, a particular caller may call from a large phone system such as a phone system at the caller's place of business. In such an example, the entry in the call history list may originally appear with the phone number for the main line at the caller's place of business. However, if the identity of the caller can be determined and an entry for the caller in a contact list maintained by the mobile communications device (204) can be found that includes a phone number for the caller's direct line, the call history list may be updated to include the phone number for the caller's direct line—such that using the entry in the call history list to initiate a subsequent call with the caller will result in the mobile communications device (204) dialing the caller's direct number rather than dialing a number for the main line of the business.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of updating contact information in a mobile communications device, the method comprising:
identifying, by the mobile communications device, call information associated with an inbound call, the call information associated with the inbound call comprising a phone number and additional information;
identifying, by the mobile communications device, contact information stored in the mobile communications device that is associated with the call information, wherein the contact information stored in the mobile communications devices comprises an entry in a call history list;
determining, by the mobile communications device, whether the contact information stored in the mobile communications device includes information contained in the call information; and
responsive to determining that the contact information stored in the mobile communications device does not include information contained in the call information, updating, by the mobile communications device, the contact information stored in the mobile communications device in dependence upon the call information.

2. The method of claim 1 wherein:
identifying, by the mobile communications device, call information associated with the inbound call further comprises:
identifying an identity of a caller that initiated the inbound call; and
identifying a phone number from which the inbound call was initiated;
identifying, by the mobile communications device, contact information stored in the mobile communications device that is associated with the call information further comprises identifying an entry in the contact information that includes contact information for the caller that initiated the inbound call;
determining, by the mobile communications device, whether the contact information stored in the mobile communications device includes information contained in the call information further comprises determining whether the entry in the contact information for the caller that initiated the inbound call includes the phone number from which the inbound call was initiated; and
updating, by the mobile communications device, the contact information stored in the mobile communications device in dependence upon the call information further comprises adding the phone number from which the inbound call was initiated to the entry in the call information that includes contact information for the caller that initiated the inbound call.

3. The method of claim 2 wherein identifying an identity of a caller that initiated the inbound call includes determining that voice recognition data associated with the caller matches a voice profile associated with contact information stored in the mobile communications device.

4. The method of claim 2 wherein identifying an identity of a caller that initiated the inbound call includes determining that speech information from the caller matches contact information stored in the mobile communications device.

5. The method of claim 2 wherein identifying an identity of a caller that initiated the inbound call includes examining a calendar to identify expected calls at the time that the inbound call was received.

6. (canceled)

7. (canceled)

8. A mobile communications device, the mobile communications device comprising a computer processor, a computer memory operatively coupled to the computer processor, the computer memory having disposed within it computer program instructions that, when executed by the computer processor, cause the mobile communications device to carry out the steps of:
identifying call information associated with an inbound call, the call information associated with the inbound call comprising a phone number and additional information;
identifying contact information stored in the mobile communications device that is associated with the call information, wherein the contact information stored in the mobile communications devices comprises an entry in a call history list;
determining whether the contact information stored in the mobile communications device includes information contained in the call information; and
responsive to determining that the contact information stored in the mobile communications device does not include information contained in the call information, updating the contact information stored in the mobile communications device in dependence upon the call information.

9. The mobile communications device of claim 8 wherein:
identifying call information associated with the inbound call further comprises:
identifying an identity of a caller that initiated the inbound call; and
identifying a phone number from which the inbound call was initiated;
identifying contact information stored in the mobile communications device that is associated with the call information further comprises identifying an entry in the contact information that includes contact information for the caller that initiated the inbound call;
determining whether the contact information stored in the mobile communications device includes information contained in the call information further comprises determining whether the entry in the contact information for the caller that initiated the inbound call includes the phone number from which the inbound call was initiated; and
updating the contact information stored in the mobile communications device in dependence upon the call information further comprises adding the phone number from which the inbound call was initiated to the entry in the call information that includes contact information for the caller that initiated the inbound call.

10. The mobile communications device of claim 9 wherein identifying an identity of a caller that initiated the inbound call includes determining that voice recognition data associated with the caller matches a voice profile associated with contact information stored in the mobile communications device.

11. The mobile communications device of claim 9 wherein identifying an identity of a caller that initiated the inbound call includes determining that speech information from the caller matches contact information stored in the mobile communications device.

12. The mobile communications device of claim 9 wherein identifying an identity of a caller that initiated the inbound call includes examining a calendar to identify expected calls at the time that the inbound call was received.

13. (canceled)

14. (canceled)

15. A computer program product for updating contact information in a mobile communications device, the computer program product disposed upon a computer readable medium, wherein the computer readable medium is not a signal and the computer program product comprises computer program instructions that, when executed, cause a computer to carry out the steps of:
identifying, by the mobile communications device, call information associated with an inbound call, the call information associated with the inbound call comprising a phone number and additional information;
identifying, by the mobile communications device, contact information stored in the mobile communications device that is associated with the call information, wherein the contact information stored in the mobile communications devices comprises an entry in a call history list;
determining, by the mobile communications device, whether the contact information stored in the mobile communications device includes information contained in the call information; and
responsive to determining that the contact information stored in the mobile communications device does not include information contained in the call information, updating, by the mobile communications device, the contact information stored in the mobile communications device in dependence upon the call information.

16. The computer program product of claim 15 wherein:
identifying, by the mobile communications device, call information associated with the inbound call further comprises:
identifying an identity of a caller that initiated the inbound call; and
identifying a phone number from which the inbound call was initiated;
identifying, by the mobile communications device, contact information stored in the mobile communications device that is associated with the call information further comprises identifying an entry in the contact information that includes contact information for the caller that initiated the inbound call;
determining, by the mobile communications device, whether the contact information stored in the mobile communications device includes information contained in the call information further comprises determining whether the entry in the contact information for the caller that initiated the inbound call includes the phone number from which the inbound call was initiated; and
updating, by the mobile communications device, the contact information stored in the mobile communications device in dependence upon the call information further comprises adding the phone number from which the inbound call was initiated to the entry in the call information that includes contact information for the caller that initiated the inbound call.

17. The computer program product of claim 16 wherein identifying an identity of a caller that initiated the inbound call includes determining that voice recognition data associated with the caller matches a voice profile associated with contact information stored in the mobile communications device.

18. The computer program product of claim 16 wherein identifying an identity of a caller that initiated the inbound call includes determining that speech information from the caller matches contact information stored in the mobile communications device.

19. The computer program product of claim 15 wherein identifying an identity of a caller that initiated the inbound call includes examining a calendar to identify expected calls at the time that the inbound call was received.

20. The computer program product of claim 15 wherein the contact information stored in the mobile communications device includes an entry in a contacts list.
